(19) United States
(12) Patent Application Publication
(10) Pub. No.: US 2015/0154444 A1
(43) Pub. Date: Jun. 4, 2015

(54) ELECTRONIC DEVICE AND METHOD

(71) Applicant: Kabushiki Kaisha Toshiba, Tokyo (JP)

(72) Inventor: Yukihiro Kurita, Tokyo (JP)

(21) Appl. No.: 14/615,393

(22) Filed: Feb. 5, 2015

Related U.S. Application Data
(63) Continuation of application No. PCT/JP2013/057703, filed on Mar. 18, 2013.

(51) Int. Cl. G06K 9/00; G06F 3/0488; G06F 17/24

(52) U.S. Cl. CPC G06K 9/00436; G06F 17/242; G06F 3/04883

(57) ABSTRACT

According to one embodiment, an electronic device includes circuitry configured to receive, when one or more first stroke is handwritten in a first mode and one or more second stroke is handwritten in a second mode different from the first mode, document data including first stroke data and second stroke data, and display, when a first display area of the first stroke at least partially overlaps a second display area of the second stroke and a first process for the document data is performed, either a first result of first process executed only for the first stroke data or a second result of the first process executed only for the second stroke data.

### CROSS REFERENCE TO RELATED APPLICATIONS

This application is a continuation application of PCT Application No. PCT/JP2013/057703, filed Mar. 18, 2013, the entire contents of which are incorporated herein by reference.

### FIELD

Embodiments described herein relate generally to a technique for processing handwritten data.

### BACKGROUND

Recently, various types of electronic devices, such as tablets, PDAs and smartphones, have been developed. Most of these electronic devices include a touchscreen display for facilitating user input.

The user can give the electronic device instructions to execute functions related to a menu or object by touching the menu or object displayed on the touchscreen display with a finger or the like.

Some of these electronic devices have a function of handwriting characters, figures, etc., on the touchscreen display by the user. A handwritten document (handwritten data) including such handwritten characters and figures is stored and viewed as necessary.

The user often uses different types of pens such as a pencil, a ballpoint pen, a marker pen, etc., and different colors depending on the object to be handwritten on paper, for example, in a notebook. Therefore, different types of pens, colors, etc., should preferably be used when handwriting characters and figures on the touchscreen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an electronic device of an embodiment.

FIG. 2 is a block diagram showing an example of a system configuration of the electronic device of the embodiment.

FIG. 3 is an illustration showing an example of a handwritten document processed by the electronic device of the embodiment.

FIG. 4 is an illustration for explanation an example of time-series data stored in a storage medium by the electronic device of the embodiment and corresponding to the handwritten document shown in FIG. 3.

FIG. 5 is an illustration showing an example of a handwritten document processed by the electronic device of the embodiment and including strokes handwritten in a plurality of drawing modes.

FIG. 6 is an illustration showing an example of time-series data (stroke data) corresponding to the strokes of FIG. 5 and excluding data of the drawing modes.

FIG. 7 is an illustration showing an example of time-series data (stroke data) corresponding to the strokes shown in FIG. 5 and including data of the drawing modes.

FIG. 8 is a block diagram showing an example of a function structure of a digital notebook application program executed by the electronic device of the embodiment.

FIG. 9 is a table showing an example of handwritten document data corresponding to the strokes shown in FIG. 5.

FIG. 10 is a table showing a configuration example of pen data used by the electronic device of the embodiment.

FIG. 11 is a table showing a configuration example of pen tip data used by the electronic device of the embodiment.

FIG. 12 is a table showing a configuration example of color data used by the electronic device of the embodiment.

FIG. 13 is a table showing another configuration example of the pen data used by the electronic device of the embodiment.

FIG. 14 is an illustration showing examples of a note view screen in a pen input mode and a note view screen in a menu display mode displayed by the electronic device of the embodiment.

FIG. 15 is an illustration showing an example of a note view screen in a detailed menu display mode displayed by the electronic device of the embodiment.

FIG. 16 is an illustration showing another example of the handwritten document processed by the electronic device of the embodiment and including strokes handwritten in a plurality of drawing modes.

FIG. 17 is an illustration showing yet another example of the handwritten document processed by the electronic device of the embodiment and including strokes handwritten in a plurality of drawing modes.

FIG. 18 is a flowchart showing an example of a procedure of handwriting processing executed by the electronic device of the embodiment.

FIG. 19 is a flowchart showing an example of a procedure of search processing executed by the electronic device of the embodiment.

### DETAILED DESCRIPTION

Various embodiments will be described hereinafter with reference to the accompanying drawings.

In general, according to one embodiment, an electronic device includes circuitry configured to receive, when one or more first stroke is handwritten in a first mode and one or more second stroke is handwritten in a second mode different from the first mode, document data including first stroke data corresponding to the first stroke and second stroke data corresponding to the second stroke; and display, when a first display area of the first stroke at least partially overlaps a second display area of the second stroke and a first process for the document data is performed, either a first result of first process executed only for the first stroke data or a second result of the first process executed only for the second stroke data.

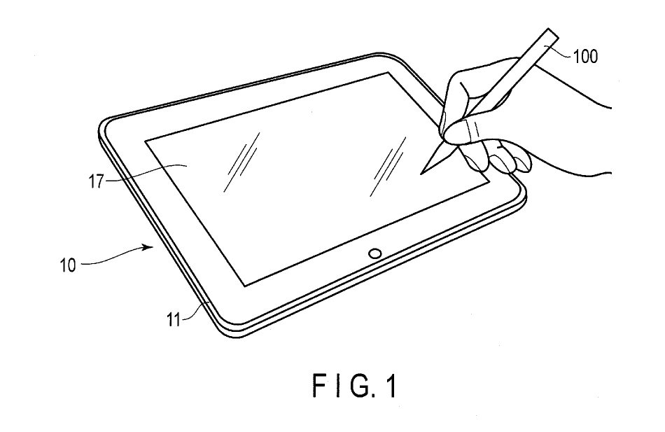

FIG. 1 is a perspective view showing an appearance of an electronic device according to one of the embodiments. The electronic device is, for example, a pen-based portable electronic device that permits a pen (stylus) or a finger to input handwritten data. The electronic device can be implemented as a tablet computer, a notebook PC, a smartphone, a PDA, etc. In the description below, it is assumed that the electronic device is implemented as a tablet computer 10. The tablet computer 10 is a portable electronic device also called a tablet or a slate computer, and includes a main unit 11 and a touchscreen display 17 as shown in FIG. 1. The touchscreen display 17 is attached to the main unit 11, superposed on the upper surface thereof.

The main unit 11 has a thin box-shaped housing. A flat panel display and a sensor configured to detect the contact position of a pen or a finger on the screen of the flat panel display are incorporated into the touchscreen display 17. The flat panel display may be a liquid crystal display (LCD) device. As the sensor, for example, a capacitance type touchpanel and an electromagnetic induction type digitizer may be used. In the description below, it is assumed that two types of sensors, i.e., the digitizer and the touchpanel are incorporated into the touchscreen display 17.

Each of the digitizer and the touchpanel is provided to cover the flat panel display screen. The touchscreen display 17 can detect not only a touch operation on the screen using a finger, but also a touch operation on the screen using a pen 100. The pen 100 may be, for example, an electromagnetic induction pen.

The user can perform a handwriting input operation of inputting a plurality of strokes in handwriting on the touchscreen display 17 by using an external object (pen 100 or finger). During a handwriting input operation, a locus of the movement of the external object (pen 100 or finger) on the screen, i.e., a locus of a stroke handwritten by the handwriting input operation is drawn in real time. The locus of each stroke is thereby displayed on the screen. The locus of the movement of the external object during the time when the external object is kept in contact with the screen corresponds to a stroke. A set of a large number of strokes, i.e., a set of a large number of loci corresponding to handwritten characters, figures or the like constitutes a handwritten document.

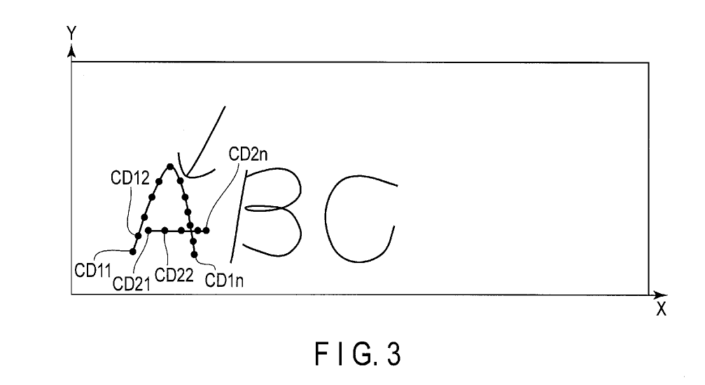

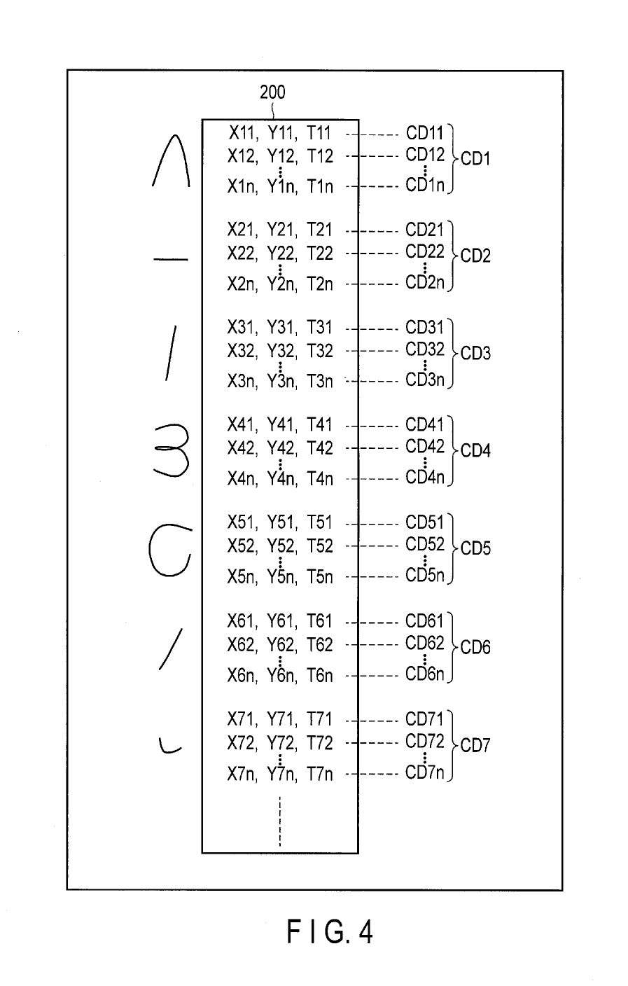

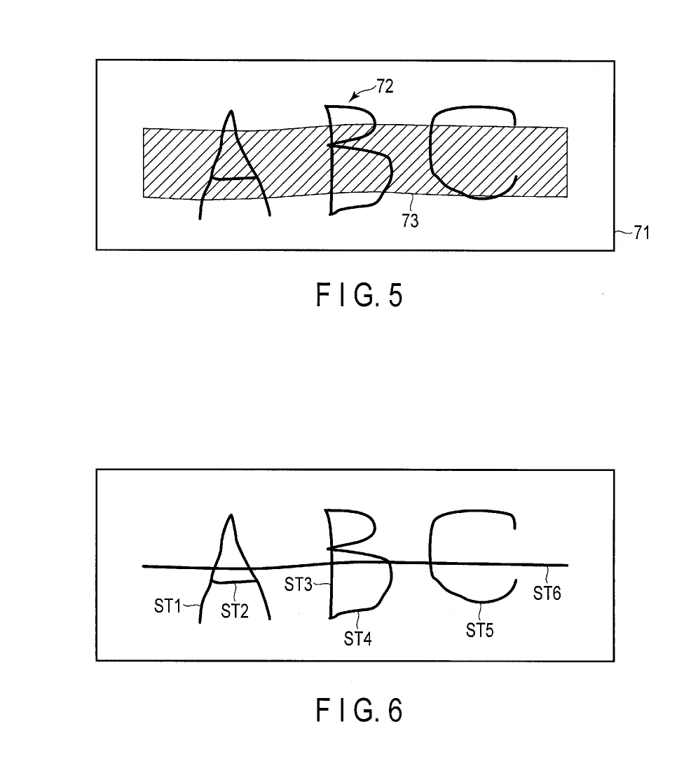

In the present embodiment, the handwritten document is stored in a storage medium not in the form of image data but in the form of handwritten document data including time-series data indicative of a series of coordinates of a locus of each stroke and indicative of the order relation of strokes, and drawing mode data (pen data) indicative of a drawing mode of each stroke. The time-series data, which will be described in detail with reference to FIG. 3 and FIG. 4, generally means a set of time-series stroke data items corresponding to a plurality of strokes, respectively. Each stroke data item may be any data capable of expressing a stroke that can be input in handwriting, and includes, for example, a coordinate data series (time-series coordinates) corresponding to respective points of a locus of the stroke. The order of arrangement of the stroke data items corresponds to the order of handwriting of the strokes, i.e., the stroke order. The drawing mode data, which will be described in detail with reference to FIG. 5 to FIG. 7, indicates, for example, a combination of a type of pen tip (line type), a line width, a color, transmittance, etc., used to draw each of the strokes.

The tablet computer 10 can read an arbitrary item of existing handwritten document data from the storage medium and display, on the screen, a handwritten document corresponding to the handwritten document data item. That is, a handwritten document where loci indicated by time-series data and corresponding to respective strokes are drawn in drawing modes indicated by drawing mode data and corresponding to the respective strokes can be displayed on the screen.

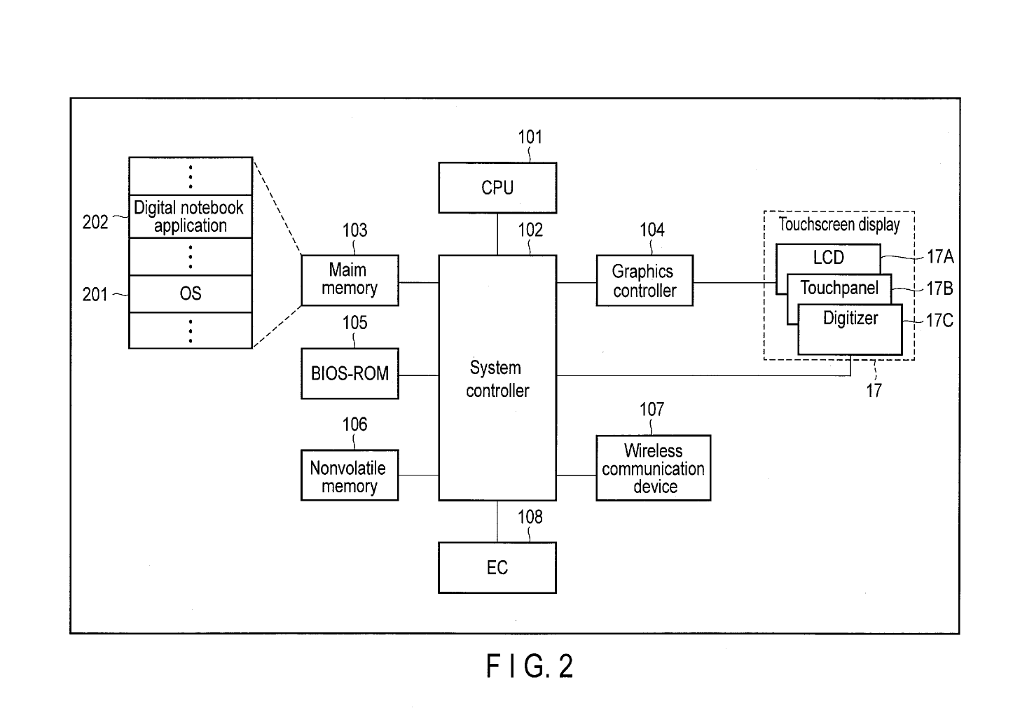

FIG. 2 is a diagram showing a system configuration of the tablet computer 10.

As shown in FIG. 2, the tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor which controls operations of each module in the tablet computer 10. The processor includes at least one circuitry. The CPU 101 executes various types of software loaded from the nonvolatile memory 106 serving as a storage device into the main memory 103. The software includes an operating system (OS) 201 and various application programs. The application programs include a digital notebook application program 202. The digital notebook application program 202 has a function of generating and displaying the handwritten document, a function of character recognition of characters handwritten on the handwritten document and figure recognition of handwritten figures, a function of searching the handwritten document, etc.

The CPU 101 also executes a basic input/output system (BIOS) stored in the BIOS-ROM 105. The BIOS is a program for hardware control.

The system controller 102 is a device which connects between a local bus of the CPU 101 and various components. The system controller 102 is equipped with a memory controller which executes access control of the main memory 103. The system controller 102 also has a function of executing communication with the graphics controller 104 via, for example, a serial bus conforming to the PCI EXPRESS standard.

The graphics controller 106 is a display controller which controls the LCD 17A used as a display monitor of the tablet computer 10. A display signal generated by the graphics controller 104 is transmitted to the LCD 17A. The LCD 17A displays a screen image on the basis of the display signal. A touchpanel 17B and a digitizer 17C are arranged on the LCD 17A. The touchpanel 17B is a capacitance type pointing device to execute input on the screen of the LCD 17A. The contact position, the movement of the contact position, etc., on the screen where the finger touches are detected by the touchpanel 17B. The digitizer 17C is an electromagnetic induction type pointing device to execute input on the screen of the LCD 17A. The contact position, the movement of the contact position, etc., on the screen where the pen contacts are detected by the digitizer 17C.

The wireless communication device 107 is a device configured to execute wireless communication such as wireless LAN or 3G mobile communication. The EC 108 is a one-chip microcomputer including an embedded controller for power management. The EC 108 has a function of powering on or off the tablet computer 10 in accordance with a power button operation by the user.

Next, a relationship between strokes (characters, marks, figures, tables, etc.) handwritten by the user and time-series data is described with reference to FIG. 3 and FIG. 4. FIG. 3 shows an example of a handwritten document handwritten on the touchscreen display 17 by using the pen 100, etc.

In the handwritten document, a character or figure may often be handwritten on an already handwritten character or figure. In FIG. 3, it is assumed that a character string “ABC” is handwritten in the order “A”, “B” and “C”, and thereafter an arrow is handwritten close to the handwritten character “A”.

The handwritten character “A” is expressed by two strokes (a locus in the form of “ [symbol] ” and a locus in the form of “-”), i.e., two loci handwritten by using, for example, the pen 100. The first handwritten locus of the pen 100 in the form of “ [symbol] ” is sampled in real time, for example, at regular intervals, and a coordinate data series (time-series coordinates) CD11, CD12 . . . CD1n corresponding to the stroke in the form of “ [symbol] ” can be thereby achieved. Similarly, the subsequent handwritten locus of the pen 100 in the form of “-” is sampled in real time, and a coordinate data series CD21, CD22 . . . CD2n corresponding to the stroke in the form of “-” can be thereby achieved.

The handwritten character “B” is expressed by two strokes, i.e., two loci handwritten by using, for example, the pen 100. The handwritten character “C” is expressed by a stroke, i.e., a locus handwritten by using, for example, the pen 100. The handwritten arrow is expressed by two strokes, i.e., two loci handwritten by using, for example, the pen 100.

FIG. 4 shows time-series data 200 corresponding to the handwritten document of FIG. 3. The time-series data 200 includes a plurality of coordinate data series (time-series coordinates) CD1, CD2 . . . , CD7. In the time-series data 200, the coordinate data series CD1, CD2 . . . , CD7 are arranged in the stroke order, i.e., in the time-series order in which the strokes were handwritten.

In the time-series data 200, the first and second coordinate data series CD1 and CD2 indicate the two strokes of the handwritten character “A”, respectively. The third and fourth coordinate data series CD3 and CD4 indicate the two strokes of the handwritten character “B”, respectively. The fifth coordinate data series CD5 indicates the stroke of the handwritten character “C”. The sixth and seventh coordinate data series CD6 and CD7 indicate the two strokes of the handwritten arrow, respectively.

Each of the coordinate data series includes a coordinate data series (time-series coordinates) corresponding to a stroke, i.e., a plurality of coordinates corresponding to a plurality of points on a locus of the stroke, respectively. In each of the coordinate data series, coordinates are arranged on a time-series basis in the order in which the stroke were handwritten. For instance, regarding the handwritten character “A”, the coordinate data series CD1 includes a coordinate data series (time-series coordinates) corresponding to points on the locus of the stroke “ [symbol] ” of the handwritten character “A”, i.e., n coordinate data CD11, CD12 . . . CD1n. The coordinate data series CD2 includes a coordinate data series corresponding to points on the locus of the stroke “-” of the handwritten character “A”, i.e., n coordinate data CD21, CD22 . . . CD2n. The number of coordinate data items may differ for each coordinate data series.

Each coordinate data item indicates an X coordinate and a Y coordinate corresponding to a point on a corresponding locus. For instance, the coordinate data CD11 indicates the X coordinate (X11) and the Y coordinate (Y11) of the start point of the stroke “ [symbol] ”. The coordinate data CD1n indicates the X coordinate (X1n) and the Y coordinate (Y1n) of the end point of the stroke “ [symbol] ”.

Furthermore, each coordinate data item may include timestamp data T corresponding to a time at which a point corresponding to the coordinate data was handwritten. The point-handwritten time may be an absolute time (e.g., year, month, day, hour, second) or a relative time with respect to a certain reference time. For instance, an absolute time (e.g., year, month, day, hour, second) when writing of a stroke has been started may be added to each coordinate data item as timestamp data, and further a relative time indicative of a difference from the absolute time may be added to each coordinate data item in the coordinate data series as timestamp data T.

As describe above, the temporal relationship between strokes can be expressed with higher accuracy by using time-series data in which timestamp data T is added to each coordinate data item.

Data (Z) indicative of writing pressure may be added to each coordinate data item.

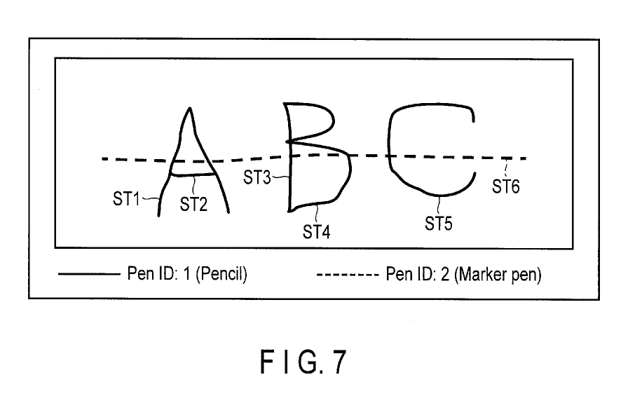

Next, the relationship between strokes (characters, marks, figures, tables, etc.) handwritten by the user and drawing mode data is described with reference to FIG. 5 and FIG. 7.

FIG. 5 shows an example of a handwritten document 71 including a plurality of strokes drawn in a plurality of drawing modes (i.e., a plurality of pens). The handwritten document 71 includes strokes of handwritten characters “ABC” 72 drawn in a first mode and a stroke of a handwritten line 73 drawn in a second mode different from the first mode.

It is assumed that “pencil” for drawing a stroke in the first mode and “marker pen” for drawing a stroke in the second mode are defined. In this case, for example, the user selects the pencil and handwrites the characters “ABC” 72, and then selects the marker pen and handwrites the line 73 on the characters “ABC” 72.

As shown in FIG. 6, the characters “ABC” 72 are constituted by five strokes ST1 to ST5 (first strokes), and the line 73 is constituted by a stroke ST6 (second stroke). The shape of each of the strokes ST1 to ST6 and the stroke order are represented by the above-described time-series data.

Incidentally, when a search (stroke search) based on strokes and character recognition are executed for the strokes ST1 to ST5, the characters and the line (figure) may be incorrectly searched or recognized since the search and recognition are executed for the strokes ST1 to ST5 of the characters 72 and the stroke ST6 of the line 73 overlapping each other. For example, when the handwritten document 71 is searched based on strokes of characters “ABC” handwritten by the user as a search key, the strokes ST1 to ST5 corresponding to “ABC” alone may not be correctly detected because the characters “ABC” 72 and the line 73 overlap each other in the handwritten document 71. In addition, for example, when character recognition is executed for the handwritten document 71, the character string “ABC” may be incorrectly recognized since the characters “ABC” 72 and the line 73 overlap each other in the handwritten document 71.

Therefore, as described above, stroke data including not only a coordinate data series corresponding to a handwritten stroke, but also drawing mode data indicative of a drawing mode of the stroke (for example, data indicative of a pen used in handwriting the stroke) is generated in the present embodiment.

In FIG. 7, drawing mode data are added to the strokes ST1 to ST5 corresponding to the handwritten characters “ABC” 72 drawn in the first mode in the handwritten document 71 and the stroke ST6 corresponding to the handwritten line 73 drawn in the second mode different from the first mode, respectively. That is, drawing mode data indicative of the first mode, for example, a pen ID “1” indicative of “pencil”, is added to the strokes ST1 to ST5 corresponding to the characters “ABC” 72, and drawing mode data indicative of the second mode, for example, a pen ID “2” indicative of “marker pen”, is added to the stroke ST6 corresponding to the line 73.

In this manner, a plurality of handwritten strokes can be processed per drawing mode (i.e., per pen) based on the drawing mode data (pen IDs) in the present embodiment. Therefore, a search based on strokes and various types of recognition such as character recognition and figure recognition can be executed with high accuracy.

In addition, as described above, a handwritten document is stored not in the form of an image or a result of character recognition, but in the form of time-series data 200 constituted by a set of time-series coordinate data items in the present embodiment. Thus, handwritten characters and figures can be processed independently of language. Therefore, the structure of the time-series data 200 of the present embodiment can be commonly used in various countries having different languages around the world.

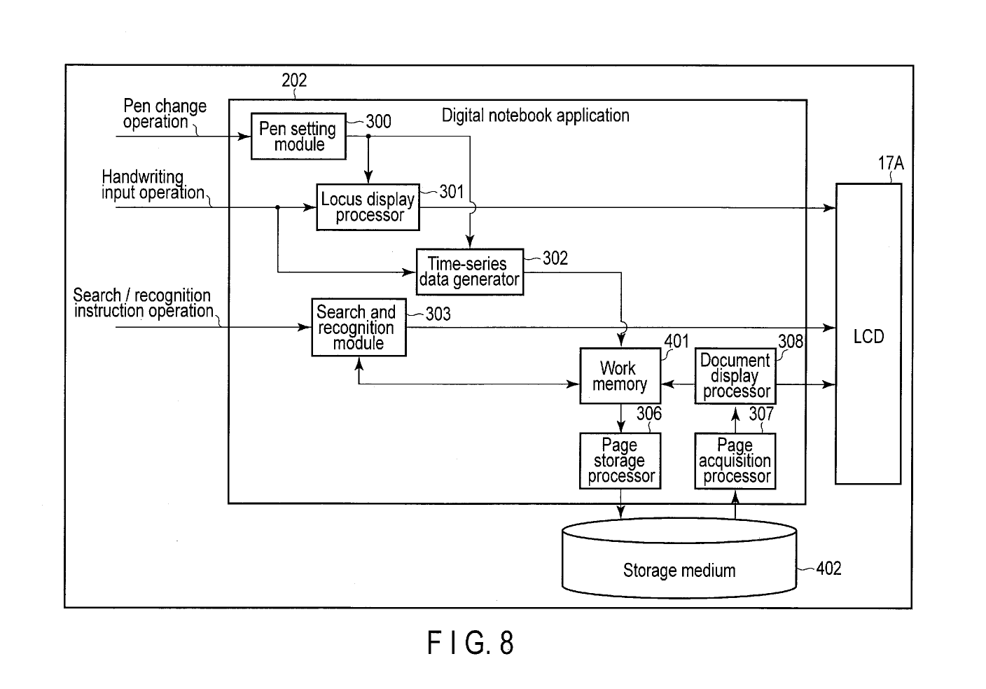

Next, a functional structure of the digital notebook application program 202 is described with reference to FIG. 8. The digital notebook application program 202 creates, displays and edits a handwritten document by using coordinate data series (time-series coordinates) input by a handwriting input operation using the touchscreen display 17. The digital notebook application program 202 can also search the handwritten document by using strokes handwritten as a search key (for example, handwritten characters and figures). The digital notebook application program 202 can also convert a character handwritten on the handwritten document to a character code (i.e., execute character recognition), and convert a handwritten figure to a graphical object (i.e., execute figure recognition).

The digital notebook application program 202 includes, for example, a pen setting module 300, a locus display processor 301, a time-series data generator 302, a search and recognition module 303, a page storage processor 306, a page acquisition processor 307 and a document display processor 308.

The touchscreen display 17 is configured to detect occurrence of events such as “touch”, “slide” and “release”. “Touch” is an event indicating that an external object has touched the screen. “Slide” is an event indicating that the contact position has moved while the external object is in contact with the screen. “Release” is an event indicating that the external object has been lifted from the screen.

For example, a plurality of icons to select a drawing mode of a stroke to be handwritten and an area where the stroke is handwritten are displayed on the screen of the touchscreen display 17. The icons to select the drawing mode includes, for example, images expressing types, colors, widths of pens corresponding to the drawing mode so as to be understood intuitively by the user. Therefore, the user can select the drawing mode as if to select a pen in reality.

The pen setting module 300 receives a “touch (tap)” event generated by the touchscreen display 17 and thereby detects a pen change operation. The “touch” event includes coordinates of a contact position. In response to the reception of the “touch” event on any one of the icons to select the drawing mode, the pen setting module 300 sets a drawing mode associated with the touched icon as a current drawing mode. For example, a drawing mode (pen) defining an arbitrary combination of a type of pen tip, a line width, a color, transmittance, etc., is associated with each of the icons to select the drawing mode.

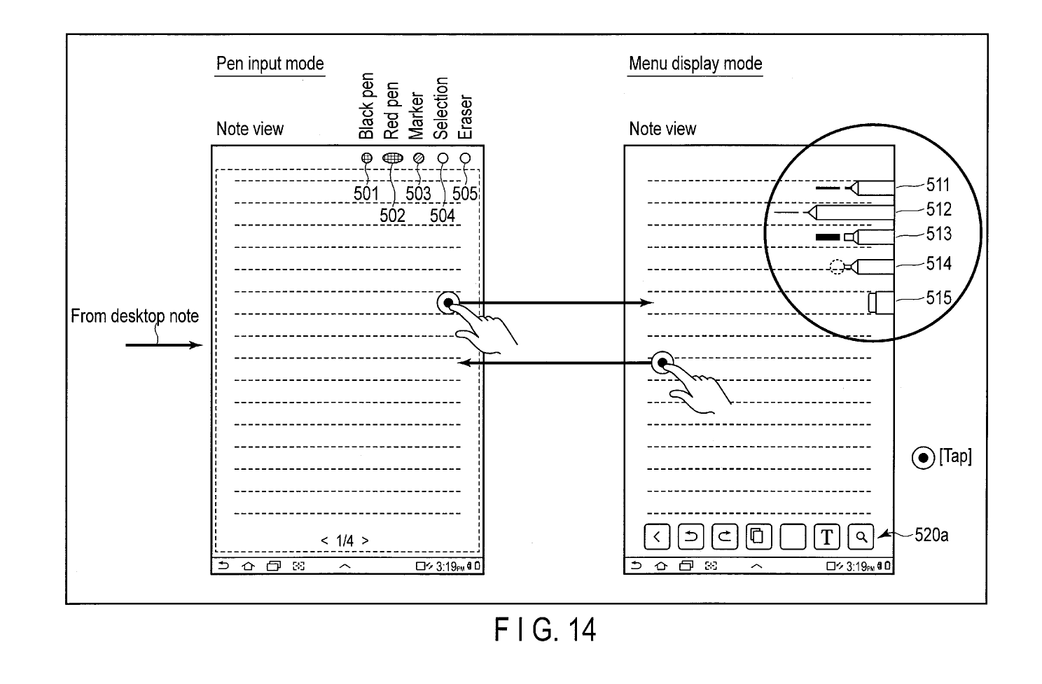

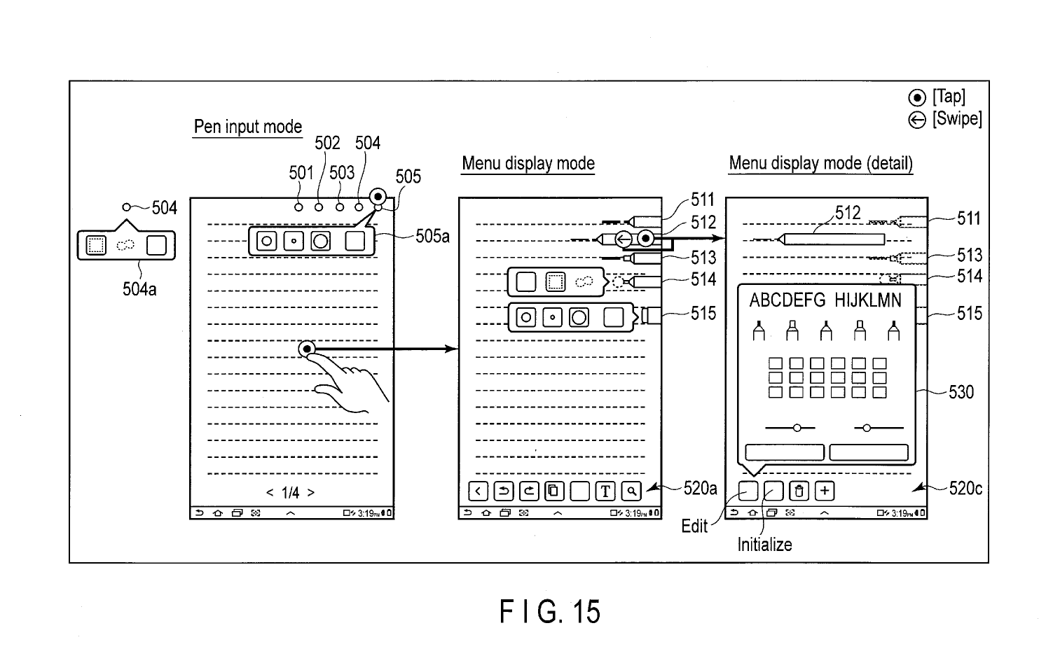

Identification data (pen ID) provided to each drawing mode may be associated with each of the icons to select the drawing mode. The pen ID indicates identification data to identify a pen having parameters such as a type of pen tip, a line width (thickness), a color, transmittance (density), etc., defined. In response to the reception of the “touch” event on an icon, the pen setting module 300 sets a drawing mode (pen) corresponding to a pen ID associated with the icon as a current drawing mode. An example of a screen where the icons to select the drawing mode are displayed is described later with reference to FIG. 14 and FIG. 15.

The locus display processor 301 and the time-series data generator 302 receive a “touch”, “slide” or “release” event generated by the touchscreen display 17, and thereby detect a handwriting input operation. The “touch” event includes coordinates of a contact position. The “slide” event includes coordinates of a contact position as a destination. The “release” event includes coordinates of a position (release position) from which the external object is lifted. Therefore, the locus display processor 301 and the time-series data generator 302 can receive a series of coordinates corresponding to a locus of the movement of the contact position from the touchscreen display 17.

The locus display processor 301 receives the series of coordinates from the touchscreen display 17. Then, based on the series of coordinates, the locus display processor 301 displays a locus of each stroke handwritten by the handwritten input operation in the drawing mode (pen) set by the pen setting module 300, on the screen of the LCD 17A in the touchscreen display 17. The locus of the pen 100 during the time when the pen 100 is kept in contact with the screen, i.e., the locus of each stroke is drawn on the screen of the LCD 17A by the locus display processor 301.

The time-series data generator 302 receives the series of coordinates output from the touchscreen display 17, and generates, based on the series of coordinates, stroke data including time-series data (coordinate data series) having the structure described above in detail with reference to FIG. 4 and drawing mode data indicative of the current drawing mode set by the pen setting module 300. In this case, the time-series data, i.e., coordinates and timestamp data corresponding to each point on the stroke and the drawing mode data may be temporally stored in a work memory 401.

The pen setting module 300 can also change the drawing mode as necessary in response to the reception of a “touch” event on any one of the icons to select the drawing mode. The user can handwrite characters and figures while changing the drawing mode as necessary. For example, the user can touch an icon to set a drawing mode “ballpoint pen” and handwrite characters, and then touch an icon to set a drawing mode “marker pen” and handwrites a line to emphasize the characters.

Therefore, with respect to a handwritten stroke, the time-series data generator 302 generates stroke data including time-series data corresponding to the stroke and drawing mode data of the stroke. Then, the time-series data generator 302 temporally stores the generated stroke data in the work memory 401.

The page storage processor 306 generates handwritten document data including the generated stroke data (stroke data temporally stored in the work memory 401) per handwritten document (or handwritten page), and stores the handwritten document data in the storage medium 402. The storage medium 402 is, for example, a storage device in the tablet computer 10.

For example, when one or more first strokes drawn in a first mode and one or more second strokes drawn in a second mode different from the first mode are handwritten on the screen, the time-series data generator 302 and the page storage processor 306 generates handwritten document data including first stroke data corresponding to the first strokes and second stroke data corresponding to the second strokes, and stores the generated data in the storage medium 402. The generated handwritten document data can be used as an input of the search and recognition module 303 described later.

The page acquisition processor 307 reads an arbitrary item of prestored handwritten document data from the storage medium 402, a server connected via the network, etc. The read handwritten document data is transmitted to the document display processor 308. The read handwritten document data can be used as input of the search and recognition module 303 described later.

The document display processor 308 analyzes the handwritten document data and displays, based on the analysis result, loci of respective strokes indicated by time-series data in drawing modes indicated by drawing mode data corresponding to the respective strokes as a handwritten document (handwritten page) on the screen. The document display processor 308 can also display various GUIs such as a menu to instruct creation, editing, delete, etc., of a handwritten document and objects to select a drawing mode (pen) of a handwritten stroke.

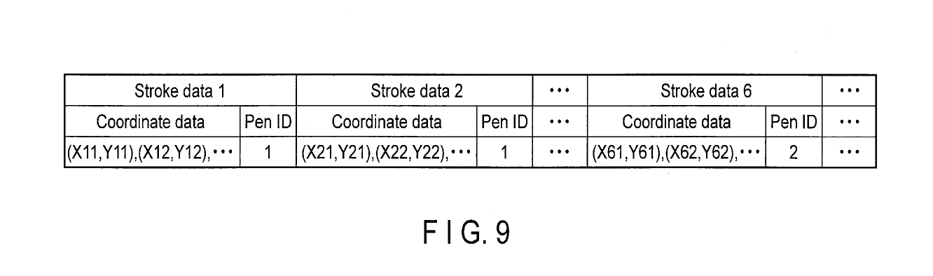

FIG. 9 shows an example of handwritten document data.

The handwritten document data includes stroke data corresponding to a plurality of strokes handwritten on the handwritten document. Each of the stroke data items includes a coordinate data series (time-series data) of a corresponding stroke and drawing mode data indicative of a drawing mode used when the stroke is drawn. In the description below, pen IDs are assumed to be used as the drawing mode data.

As described above with reference to FIG. 4, a coordinate data series (time-series data) includes a plurality of coordinates (for example, X coordinates and Y coordinates) corresponding to a plurality of points on a locus of a stroke, respectively. A pen ID indicates identification data provided to a pen (drawing mode) used when the stroke is handwritten.

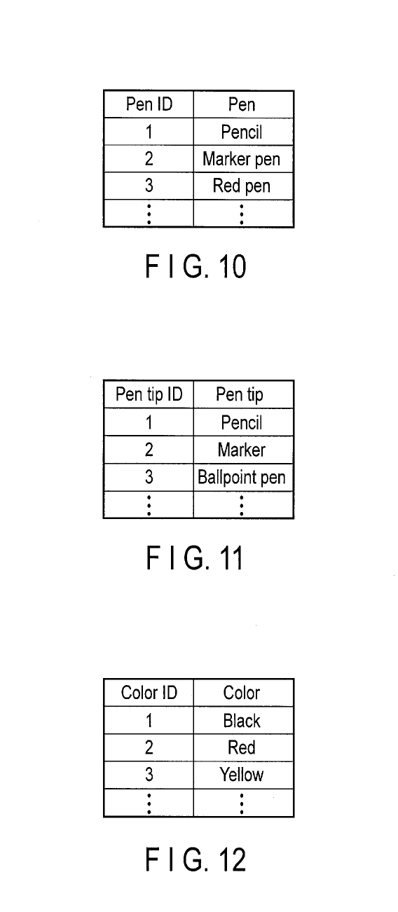

A configuration example of pen data defining pen IDs is described with reference to FIG. 10. The pen data includes a plurality of entries corresponding to a plurality of pens. For example, drawing modes preliminarily defined by the digital notebook application program 202 are associated with the pens. That is, various parameters indicative of a shape of pen tip, a color, a thickness, density (transmittance), a line type, etc., are preliminarily set to each pen.

Each entry of the pen data includes, for example, “pen ID” and “pen”. In an entry corresponding to a pen, “pen ID” indicates identification data provided to the pen. “Pen” indicates a type of the pen. Therefore, correspondence between a pen defined by the digital notebook application program 202 and a pen ID is indicated in each entry. In an example shown in FIG. 10, the pen data indicates a plurality of pens such as “pencil”, “marker pen” and “red pen” defined by the digital notebook application program 202, and identification data (pen ID) of each of the pens.

Each of the stroke data items shown in FIG. 9 includes, for example, a pen ID indicative of any one of the pens indicated by the pen data shown in FIG. 10. Therefore, in the example shown in FIG. 9 and FIG. 10, “stroke data 1” and “stroke data 2” correspond to strokes drawn with “pencil” whose pen ID is 1, and “stroke data 6” corresponds to a stroke drawn with “marker pen” whose pen ID is 2.

The pen (drawing mode) to be used may be identified by various parameters indicative of a shape of pen tip, a color, a thickness, density (transmittance), a line type, etc.

Another configuration example of the pen data defining pen IDs is described with reference to FIG. 11 to FIG. 13. FIG. 11 shows a configuration example of pen tip data. The pen tip data includes a plurality of entries corresponding to various types of pen tips. Each entry includes, for example, “pen tip ID” and “pen tip”. In an entry corresponding to a pen tip, “pen tip ID” indicates identification data provided to the pen tip. “Pen tip” indicates a shape of the pen tip. For example, “pencil”, “marker pen”, “ballpoint pen”, etc., indicative of preliminarily defined shapes are set to “pen tip”.

FIG. 12 shows a configuration example of color data. The color data includes a plurality of entries corresponding to various colors. Each entry includes, for example, “color ID” and “color”. In an entry corresponding to a color, “color ID” indicates identification data provided to the color. “Color” indicates the color. For example, “black”, “red”, “yellow”, etc., indicative of preliminarily defined colors are set to “color”. Values indicative of colors such as RGB values may also be set to “color”.

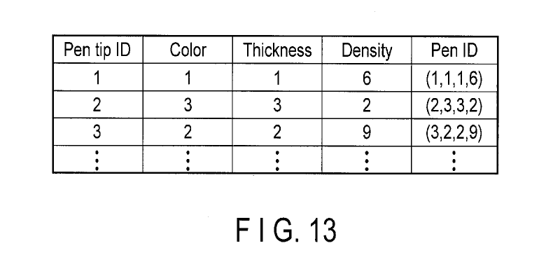

FIG. 13 shows a configuration example of the pen data defined by using the pen tip data, the color data, etc. The pen data includes a plurality of entries corresponding to a plurality of pens. Each entry of the pen data includes, for example, “pen tip”, “color”, “thickness”, “density” and “pen ID”.

In an entry corresponding to a pen, “pen tip” indicates a shape of a pen tip of the pen, i.e., a shape of a stroke drawn by the pen. For example, one of values of “pen tip ID” defined by the pen tip data of FIG. 11 is set to “pen tip”. “Color” indicates a color of the pen, i.e., a color of the stroke drawn by the pen. For example, one of values of “color ID” defined by the color data of FIG. 12 is set to “color”.

“Thickness” indicates a thickness of the pen, i.e., a thickness of the stroke drawn by the pen. For example, a value within a preliminarily-defined range, a value in a unit of point or the like is set to “thickness”. “Density” indicates density of the pen, i.e., density (transmittance) of the stroke drawn by the pen. For example, a value within a preliminarily-defined range or a value in a unit of percent is set to “density”. “Pen ID” indicates identification data provided to the pen. For example, a value obtained by combining values indicated by “pen tip”, “color”, “thickness” and “density”, respectively, is set to “pen ID”. For example, in an entry shown in FIG. 13 where “pen tip” is 1, “color” is 1, “thickness” is 1 and “density” is 6, (1, 1, 1, 6) obtained by combining these values is set to “pen ID”. The pen ID obtained by thus combining parameters indicative of various pen attributes can be used as a pen ID of stroke data in the handwritten document data as shown in FIG. 9.

The search and recognition module 303 can execute various types of processing such as search processing and recognition processing for the handwritten document data configured as described above. It is assumed that, when one or more first strokes drawn in a first mode and one or more second strokes drawn in a second mode different from the first mode are handwritten, handwritten document data including first stroke data corresponding to the first strokes and second stroke data corresponding to the second strokes is input to the search and recognition module 303. As shown in the example of FIG. 5, at least a part of the one or more first strokes may overlap the one or more second strokes.

When a display area (first display area) of the first stroke at least partially overlaps a display area (second display area) of the second stroke and a first process for the document data is performed, the search and recognition module 303 can display either a result (first result) of the first process (for example, search processing or recognition processing) executed only for the first stroke data or a result (second result) of the first process executed only for the second stroke data.

For example, when the first process is search processing executed for handwritten document data based on third stroke data corresponding to a stroke serving as a search key (hereinafter also referred to as a third stroke), the search and recognition module 303 can display any one of a result of the search processing executed only for the first stroke data based on the third stroke data, a result of the search processing executed only for the second stroke data based on the third stroke data, and a result of the search processing executed for the first stroke data and the second stroke data based on the third stroke data.

More specifically, the search and recognition module 303 searches a plurality of handwritten documents stored in the storage medium 402, a handwritten document currently displayed on the screen, etc. (hereinafter also referred to as target handwritten documents), based on the third stroke serving as a search key in response to an operation to instruct a search. The third stroke is, for example, one or more strokes constituting a handwritten character and figure, and is input by handwriting of the user.

The search and recognition module 303 extracts stroke data per drawing mode (pen ID) from handwritten document data corresponding to the target handwritten documents. Then, the search and recognition module 303 searches the stroke data per drawing mode based on the third stroke data corresponding to the third stroke serving as a search key. For example, when at least a part of the area where the one or more first strokes are drawn overlaps the area where the one or more second strokes are drawn, the search and recognition module 303 searches the first stroke data based on the third stroke data and searches the second stroke data based on the third stroke data.

The search and recognition module 303 calculates one or more first feature amounts corresponding to the one or more first strokes by using the first stroke data, calculates one or more second feature amounts corresponding to the one or more second strokes by using the second stroke data, and calculates a third feature amount corresponding to the third stroke based on the third stroke data. Then, the search and recognition module 303 detects a stroke corresponding to the third stroke from the one or more first strokes based on the one or more first feature amounts and the third feature amount, and detects a stroke corresponding to the third stroke from the one or more second strokes based on the one or more second feature amounts and the third feature amount.

For example, the search and recognition module 303 calculates the feature amount corresponding to the third stroke handwritten as a search key by analyzing the third stroke data corresponding to the search key. The search and recognition module 303 calculates, for example, a feature amount indicative of a shape such as a slope of the stroke by using a coordinate data series corresponding to the third stroke. In this feature amount, features other than the shape such as a size (length) of the stroke and the number of coordinate points (the number of coordinate data items) sampled on the stroke are normalized.

Similarly, the search and recognition module 303 calculates the one or more feature amounts corresponding to the one or more first strokes, respectively, by analyzing the first stroke data corresponding to the one or more first strokes in the handwritten document data. Then, the search and recognition module 303 determines whether a feature amount corresponding to the feature amount of the search key is present in the one or more feature amounts corresponding to the one or more first strokes in the target handwritten documents by executing a handwriting search using the feature amounts corresponding to the first strokes and the feature amount corresponding to the search key. That is, the search and recognition module 303 determines whether a stroke similar to the search key (i.e., a stroke near to the search key) is present in the one or more first strokes by using the one or more feature amounts corresponding to the one or more first strokes and the feature amount of the search key. For example, if a feature amount having a degree of similarity to the feature amount corresponding to the search key equal to or higher than a threshold amount is included in the one or more feature amounts corresponding to the one or more first strokes, the search and recognition module 303 detects a stroke having this feature amount in the one or more first strokes, i.e., a stroke similar to the search key.

Similarly, the search and recognition module 303 detects a stroke similar to the search key from the one or more second strokes of the second mode in the handwritten document data. The search and recognition module 303 thus searches a stroke similar to the stroke of the search key from strokes included in the handwritten documents per drawing mode.

When at least a part of the area where the one or more first strokes are drawn overlaps the area where the one or more second strokes are drawn, the search and recognition module 303 displays, on the screen of the touchscreen display 17, any one of a result of the search processing (first process) executed only for the first stroke data, a result of the search processing executed only for the second stroke data, and a result of the search processing executed for the first stroke data and the second stroke data.

For example, when the target handwritten document is already displayed, the search and recognition module 303 may highlight and display the detected stroke (stroke similar to the search key) as the processing result. The search and recognition module 303 may also detects handwritten documents including the stroke similar to the search key from a plurality of handwritten documents (handwritten document data) stored in the storage medium 402, the server, etc., and display a list of thumbnails of the detected handwritten documents.

As described above, the search and recognition module 303 processes a plurality of strokes in handwritten documents per drawing mode (i.e., per pen). Therefore, a search based on a stroke can be executed with high accuracy even if strokes of different drawing modes overlap each other or are adjacent to each other.

When the first process is recognition processing for the handwritten document data, the search and recognition module 303 can display any one of a result of the recognition processing executed only for the first stroke data, a result of the recognition processing executed only for the second stroke data, and a result of the recognition processing executed for the first stroke data and the second stroke data. When the first process is character recognition processing executed for the handwritten document data, the search and recognition module 303 can display any one of a result of the character recognition processing executed only for the first stroke data, a result of the character recognition processing executed only for the second stroke data, and a result of the character recognition processing executed for the first stroke data and the second stroke data.

More specifically, the search and recognition module 303 executes the character recognition and the figure recognition for a handwritten document stored in the storage medium 402, a handwritten document currently displayed on the screen, etc. (target handwritten document), in response to an operation to instruct recognition.

The search and recognition module 303 extracts stroke data per drawing mode (pen ID) from handwritten document data corresponding to the target handwritten document. Then, the search and recognition module 303 executes the character recognition and the figure recognition for the stroke data per drawing mode. For example, when at least a part of the area where the one or more first strokes are drawn overlaps the area where the one or more second strokes are drawn, the search and recognition module 303 executes the character recognition processing (or figure recognition processing) for the first stroke data and executes the character recognition processing (or figure recognition processing) for the second stroke data.

The search and recognition module 303 recognizes a character code and a graphical object corresponding to the one or more first strokes by using the first stroke data corresponding to the one or more first strokes of the first mode. The search and recognition module 303 recognizes a handwritten character on the handwritten document by using first stroke data and character dictionary data. That is, the search and recognition module 303 recognizes a handwritten character from the one or more first strokes on the handwritten document. The character dictionary data is prestored in the storage medium 402 and includes a plurality of entries indicative of features of a plurality of characters (character codes).

For example, the search and recognition module 303 detects a plurality of blocks (handwritten blocks) by executing grouping processing for the first stroke data to be subjected to the recognition processing. In the grouping processing, the first stroke data to be subjected to the recognition processing are grouped such that stroke data corresponding to strokes adjacent to each other are put in the same block.

The search and recognition module 303 converts a block to be processed of the detected blocks into a character code. The search and recognition module 303 calculates a degree of similarity between the handwritten character (one or more strokes included in the block to be processed) and each of the character codes by using the character dictionary data. The search and recognition module 303 calculates the degree of similarity between the handwritten character and the character codes based on, for example, shapes and stroke orders of the characters. Then, the search and recognition module 303 converts the handwritten character into a character code having the highest degree of similarity with respect to the handwritten character.

The search and recognition module 303 may display (preview) the character code corresponding to the handwritten character on the handwritten document based on the result of the character recognition. That is, the search and recognition module 303 replaces the handwritten character displayed on the handwritten document with the corresponding character code.

The search and recognition module 303 may generate character code data indicative of the character code corresponding to the handwritten character on the handwritten document based on the result of character recognition. The search and recognition module 303 may temporally store the generated character code data in the work memory 401, etc.

The search and recognition module 303 also recognizes a handwritten figure on the handwritten document by using the first stroke data. The search and recognition module 303 converts a block to be processed of the blocks obtained by executing the grouping processing for the first stroke data to be subjected to the recognition processing as described above, into one of a plurality of graphical objects. The handwritten figure included in the handwritten document is converted into a graphical object which can be processed by drawing application programs such as PowerPoint (Registered Trademark).

The search and recognition module 303 recognizes a graphical object from the one or more first strokes. For example, the search and recognition module 303 prestores figure dictionary data indicative of features of the respective graphical objects, and calculates a degree of similarity between the handwritten figure (one or more strokes included in the block to be processed) and each of the graphical objects. Then, the search and recognition module 303 converts the handwritten figure into a graphical object having the highest degree of similarity with respect to the handwritten figure.

The degree of similarity is, for example, a degree of similarity between a feature amount based on time-series data of the handwritten figure (strokes) and a feature amount based on an outline (shape) of the graphics object. When the degree of similarity is calculated, the handwritten figure may be rotated and scaled up or down as necessary, and a degree of similarity between the handwritten figure rotated or scaled up or down and each of the graphical objects is calculated. Then, the graphical object having the highest degree of similarity with respect to the handwritten figure is selected, and the selected graphical object is deformed based on the processing executed for the handwritten figure, i.e., rotation, scaleup or scaledown. The deformed graphical object is displayed instead of the handwritten figure.

During the calculation of the degree of similarity, locus data of the strokes of the handwritten figure and locus data of each of the graphical objects are each regarded as a set of vectors, and the degree of similarity can be calculated by comparing these sets of vectors with each other. The handwritten figure can be thereby easily converted into a drawing document (application data) of PowerPoint (Registered Trademark), etc.

The search and recognition module 303 may display (preview), on the screen, the graphical object corresponding to the handwritten figure on the handwritten document based on the result of the figure recognition. That is, the search and recognition module 303 replaces the handwritten figure displayed on the handwritten document with the corresponding graphical object.

The search and recognition module 303 may generate graphical object data indicative of the graphical object corresponding to the handwritten figure on the handwritten document based on the result of the figure recognition. The search and recognition module 303 may temporally store the generated graphical object data in the work memory 401, etc.

Similarly, the search and recognition module 303 recognizes a character code and a graphical object corresponding to the one or more second strokes by using the second stroke data corresponding to the one or more second strokes of the second mode.

When at least a part of the area where the one or more first strokes are drawn overlaps the area where the one or more second strokes are drawn, the search and recognition module 303 displays, on the screen of the touchscreen display 17, any one of the result of the recognition processing (first process) executed only for the first stroke data, the result of the recognition processing executed only for the second stroke data, and the result of the recognition processing executed for the first stroke data and the second stroke data.

As the processing result, for example, the search and recognition module 303 displays the character code corresponding to the handwritten character on the handwritten document and displays the graphical object corresponding to the handwritten figure.

As described above, the search and recognition module 303 processes a plurality of strokes in the handwritten document per drawing mode (i.e., per pen). Therefore, strokes of different drawing modes are not recognized as strokes constituting the same character or figure even if the strokes of different drawing modes overlap each other or are adjacent to each other. Therefore, the character recognition and the figure recognition can be executed with high accuracy.

Next, an example of a screen to set a pen defining a drawing mode is described with reference to FIG. 14 and FIG. 15.

FIG. 14 shows a relationship between a note view screen displayed in a pen input mode and a note view screen displayed in a menu display mode.

The document display processor 308 displays the note view screen where a page (handwritten page) can be newly created and existing pages can be viewed and edited. The note view screen has two display styles corresponding to two display modes. Each module in the digital notebook application program 202 can be operated in accordance with the two modes, i.e., the pen input mode and the menu display mode.

The pen input mode is a mode where handwriting input can be executed. In the pen input mode, the document display processor 308 displays the note view screen shown on the left of FIG. 14. This note view screen is a screen where handwriting input can be executed. In the note view screen, a rectangular area enclosed in dashed lines is a handwriting available area. In the handwriting available area, input from the digitizer 17C is used for drawing, not as an event indicating a gesture such as a tap or swipe. In contrast, in areas other than the handwriting available area, input from the digitizer 17C can be used as an event indicating a gesture such as a tap or swipe. Input from the touchpanel 17B is not used for drawing, but used as an event indicating a gesture such as a tap or swipe.

In the note view screen corresponding to the pen input mode, an arbitrary page in an arbitrary item of handwritten document data selected by the user can be displayed. In the pen input mode, a minimum user interface is displayed to secure a handwriting available area that is as large as possible in the note view screen. In the present embodiment, a user interface to support the user's handwriting input operations using the pen 100 is displayed at the end, for example, the upper end of the note view screen.

The user interface is a graphical user interface to allow the user to easily switch modes (types) of drawing executed based on the input from the digitizer 17C. For example, the drawing modes can include attributes (color, thickness, shape, density, transmittance, etc.) of a stroke drawn based on the input from the digitizer 17C, attributes (thickness, shape, etc.) of a locus of an eraser (erasing stroke) drawn based on the input from the digitizer 17C, attributes (shape, etc.) of a frame for range selection drawn based on the input from the digitizer 17C, etc.

The user interface includes a plurality of icons (buttons) 501 to 505 corresponding to a plurality of drawing modes (i.e., a plurality of pens) to allow the user to easily switch the drawing modes (drawing types). The icons 501 to 505 are placed in a single horizontal row at the upper end of the screen so as not to reduce the handwriting available area.

Each of the icons (buttons) 501 to 505 has a small circular shape so as not to reduce the handwriting available area. Of the icons (buttons) 501 to 505, icons 501, 502 and 503 correspond to three different modes to draw handwritten strokes, respectively. That is, the three different modes to draw handwritten strokes are assigned to the icons 501, 502 and 503, respectively.

For example, pen type attributes such as color=black, thickness (line width)=n points, and pen tip=pencil are assigned to the icon 501 as a mode to draw handwritten strokes. In this case, the icon 501 may be an image of a small black-painted circle.

For example, pen type attributes such as color=red, thickness (line width)=m points, and pen tip=ballpoint pen are assigned to the icon 502 as another mode to draw handwritten strokes. In this case, the icon 501 may be an image of a small red-painted circle.

For example, pen type attributes such as color=yellow, thickness (line width)=2m points, and pen tip=marker pen are assigned to the icon 503 as yet another mode to draw handwritten strokes. In this case, the icon 501 may be an image of a small yellow-painted circle.

The user can easily switch the drawing modes of handwritten strokes to be used, i.e., pen types to be used by simply carrying out a single action of tapping any one of the icons 501, 502 and 503 with the pen 100 or the finger. In response to the detection of a tap operation on any one of the icons 501, 502 and 503 (pen change operation) carried out by the user, the pen setting module 300 sets a drawing mode (pen) associated with the tapped icon as a current drawing mode.

The icon 504 corresponds to a drawing mode to select a range on the note view screen. That is, the drawing mode to select a range on the note view screen, for example, a mode to draw a rectangle or a free frame for range selection is assigned to the icon 504. The icon 505 corresponds to a drawing mode that allows handwritten strokes on the note view screen to be erased (to become transparent). That is, the drawing mode that allows handwritten strokes on the note view screen to be erased (to become transparent) is assigned to the icon 505. For example, an arbitrary handwritten stroke on the note view screen can be erased by drawing a locus of the movement of the pen 100 (erasing stroke) in the same color as a background color of the page, or drawing an erasing stroke having a transparent attribute to make the intersection of the erasing stroke and another handwritten stroke transparent.

Therefore, in the present embodiment, the user can easily switch not only the pen types (red pen, black pen and marker pen), but also the pens, the range selection tool and the eraser tool by simply carrying out a single action of tapping any one of the icons 501, 502, 503, 504, and 505 with the pen 100 or the finger. The selected one of the icons 501, 502, 503, 504 and 505 is highlighted. In this case, the selected icon may increase in size and a decorative frame may be displayed around the selected icon.

For example, when the icon 501 of the black pen is selected (tapped), the pen setting module 300 sets the pen type attributes of color=black, thickness (line width)=n points, and pen tip=pencil associated with the icon 501 as a current drawing mode (pen). When the handwriting input is carried out using the pen 100, the locus display processor 301 displays a black stroke (locus) on the note view screen in accordance with the movement of the pen 100. The time-series data generator 302 generates stroke data corresponding to a stroke input via the note view screen. As described above, the generated stroke data includes a coordinate data series corresponding to the stroke and drawing mode data indicative of the drawing mode (pen) of the stroke.

When the selection button 504 is selected, the locus display processor 301 selects a range on the note view screen in accordance with a drag operation using the pen 100 or the finger.

In a conventional interface, the user is required to carry out a plurality of operations including selecting a color, selecting a thickness, etc., while following a hierarchical menu. If a plurality of menus including a menu to select a color, a menu to select a thickness, etc., are displayed together on the screen instead of the hierarchical menu, a handwriting available area is reduced.

As described above, in the present embodiment, the small icons 501 to 505 (minimum pens) to which the different drawing modes are assigned, respectively, are displayed on the note view screen. Therefore, the large handwriting available area can be obtained and the pen types (red pen, black pen and marker pen), the range selection and the eraser can be quickly switched by a single action.

When the finger swipes the note view screen, the document display processor 308 can change a page displayed on the note view screen to another page. For example, when the finger swipes the note view screen to the right side, the document display processor 308 displays the next page of a currently displayed page on the note view screen. If the currently displayed page is the first page of a note file, the second page of the note file is displayed on the note view screen in response to the swipe to the right side.

Further, if the finger taps an area of the note view screen other than the icons, the document display processor 308 switches the display mode to the menu display mode. The menu display mode is a mode where a menu to set the drawing modes can be at least displayed.

In the menu display mode, the document display processor 308 displays, on the note view screen, another user interface (pen menu) larger than the user interface including the small icons 501 to 505 instead of the user interface as shown on the right of FIG. 14 (circled icon group). That is, the area of the user interface including the circled icon group is larger than the area of the user interface including the small icons 501 to 505. The document display processor 308 also displays a menu 520a on the note view screen.

In the menu display mode, handwriting input to the note view screen is not executed. In the note view screen of the menu display mode, the input from the digitizer 17C and the input from the touchpanel 17B are each used as an event indicating a gesture such as a tap, swipe or pinch operation.

The pen menu on the note view screen in the menu display mode allows the user to see what functions correspond to the small icons 501 to 505 displayed in the pen input mode. The pen menu on the note view screen also allows the user to set (or change) the drawing modes corresponding to the icons 501 to 505 and to call various functions that can be applied to a page created or edited by the user.

As described above, since the small user interface to which a minimum function such as switching the pen types is assigned is displayed on the note view screen in the pen input mode, the user can effectively use the handwriting input available area and concentrate on handwriting input to the page. In addition, the user can easily switch the display mode to the menu display mode where the functions of the icons 501 to 505 can be seen and functions (including setting and change of the drawing modes) to be applied to the page can be called, by carrying out a simple operation of tapping the note view screen.

On the note view screen in the menu display mode, the pen menu which is the other user interface larger than the user interface including the small icons 501 to 505 is displayed instead of this user interface. The pen menu corresponds to the modes of drawing executed based on the input from the digitizer 17C and includes a plurality of big icons (buttons) 511 to 515 different from the small icons 501 to 505. The user can see the icons 511 to 515 and thereby understand what functions are assigned to the small icons 501 to 505 displayed in the pen input mode.

Each of the icons 511 to 515 may be an image to realistically express a function (drawing mode) corresponding to the icon. The icons 511 to 515 correspond to the small icons 501 to 505, respectively. In the pen input mode, the small icons 501 to 505 corresponding to the black pen, the red pen, the marker pen, the selection (range selection) and the eraser are placed in a single horizontal row in this order. The icons 511 to 515 corresponding to the black pen, the red pen, the marker pen, the selection and the eraser are placed in a single vertical row in the same order. The orientation of the row of the icons is different in the pen input mode and the menu display mode, but the order of the black pen, the red pen, the marker pen, the selection and the eraser is not changed in both the modes. Therefore, the user can easily understand that the icons 511 to 515 correspond to the small icons 501 to 505, respectively.

The icon 511 may be an image of a pen (for example, an image of a side view of a pen) larger and more realistic than the small icon 501. The circular shape of the icon 501 schematically expresses a front view of the pen tip. The icon 511 can be constituted by a three-dimensional image expressing the side view of the pen. The pen tip of the icon 511 is displayed in black and in a thickness corresponding to the currently set thickness of the black pen. As shown in FIG. 14, a black line of the thickness corresponding to the currently set thickness of the black pen may be displayed near the pen tip.

The icon 512 may be an image of a pen (for example, an image of a side view of a pen) larger and more realistic than the small icon 502. The circular shape of the icon 502 schematically expresses a front view of the pen tip. The icon 512 is constituted by a three-dimensional image expressing the side view of the pen. The pen tip of the icon 512 is displayed in red and in a thickness corresponding to the currently set thickness of the red pen. As shown in FIG. 14, a red line of the thickness corresponding to the currently set thickness of the red pen may be displayed near the pen tip.

The icon 513 may be an image of a pen (for example, an image of a side view of a pen) larger and more realistic than the small icon 503. The circular shape of the icon 503 schematically expresses a front view of the pen tip. The icon 513 is constituted by a three-dimensional image expressing the side view of the pen. The pen tip of the icon 513 is displayed in yellow and in a thickness corresponding to the currently set thickness of the yellow pen. As shown in FIG. 14, a yellow line of the thickness corresponding to the currently set thickness of the yellow pen may be displayed near the pen tip.

Similarly, each of the icons 514 and 515 may be an image larger and more realistic than the icons 504 and 505.

The icons 511 to 515 each having the elongate shape are placed in the single vertical row on the note view screen such that the longitudinal direction of these icons corresponds to the horizontal direction of the note view screen. The position of a currently selected icon on the note view screen is automatically changed. For example, when the display mode is switched from the pen input mode to the menu display mode while the icon 502 is selected by the user, or when the icon 512 is selected by the user on the note view screen in the menu display mode, the position of the icon 512 is changed. In this case, the image of the pen used as the icon 512 may be displayed so as to protrude toward the center of the screen compared to the pen images of the other icons as shown in FIG. 14. Such a change of the display position of the selected icon allows the user to easily understand which icon is currently selected.

When any one of the icons 511 to 515 is swiped to the left side (or the selected icon is further tapped), the document display processor 308 can display a detailed setting menu to set a drawing mode corresponding to the swiped icon on the note view screen. The user can change the drawing mode assigned to the swiped icon by controlling the detailed setting menu. The user can also create a new drawing mode by controlling the detailed setting menu. In this case, a new small icon and a new large realistic icon to which the new drawing mode is assigned are displayed on the note view screen of the pen input mode and the note view screen of the menu display mode, respectively, by the document display processor 308.

The menu 520a displays a plurality of icons (buttons) to which a plurality of functions are assigned. The contents of the menu 520a, i.e., types of the icons displayed in the menu 520a are automatically changed in accordance with the contents of a page currently displayed on the note view screen. An icon associated with a sub-menu can be displayed in the menu 520a. The user can select an icon corresponding to a target function from the sub-menu.

As shown in FIG. 15, sub-menus can be assigned to several icons displayed on the note view screen in the pen input mode. Similarly, the sub-menus can also be assigned to several icons displayed on the note view screen in the menu display mode.

In FIG. 15, it is assumed that sub-menus are assigned to the icon 504 for range selection and the icon 505 serving as an eraser, respectively.

When the icon 504 is tapped by the finger or the pen 100, the document display processor 308 displays a sub-menu 504a on the note view screen. In the sub-menu 504a, three icons corresponding to “rectangle”, “free frame” (free hand frame) and “select all” are displayed. The user can select one of these three selection tools. When the icon corresponding to “select all” is selected, the locus display processor 301 can select the entirety of the currently displayed page.

When the icon 505 is tapped by the finger or the pen 100, the document display processor 308 displays a sub-menu 505a on the note view screen. In the sub-menu 505a, three icons defining a thickness of the eraser (thickness of a stroke of the eraser) and an icon defining “erase all”.

On the note view screen of the menu display mode, too, a sub-menu having the same contents as those of the sub-menu 504a can be associated with the icon 514 and displayed, and a sub-menu having the same contents as those of the sub-menu 505a can be associated with the icon 515 and displayed.

On the note view screen of the menu display mode, when any one of the icons 511 to 515 is swiped to the left side by the finger or the pen 100 (or the selected icon is further tapped by the finger or the pen 100), the document display processor 308 displays the swiped icon (for example, icon 512) in the center of the note view screen and grays out the other icons as shown on the right of FIG. 15. Then, the document display processor 308 displays another menu 520c on the note view screen instead of the menu 520a. For example, if an “edit” icon in the menu 520c is tapped by the finger or the pen 100, the document display processor 308 displays a detailed setting menu 530 to set a drawing mode on the note view screen. The user can designate a class of pen tip (writing brush, fountain pen, pencil, ballpoint pen, marker pen, etc.), a color, thickness and density to be assigned to the icon 512 (i.e., icon 502) by controlling the detailed setting menu 530. The class of pen tip is selected from icons (images) of, for example, a writing brush, a fountain pen, a pencil, a ballpoint pen, a marker pen, etc. The color is selected from, for example, a tiled palette showing a plurality of colors. The thickness and the density are set by, for example, adjusting sliders. The pen setting module 300 sets the drawing mode assigned to the icon 512, i.e., the designated class of pen tip, color, thickness and density as a current drawing mode.

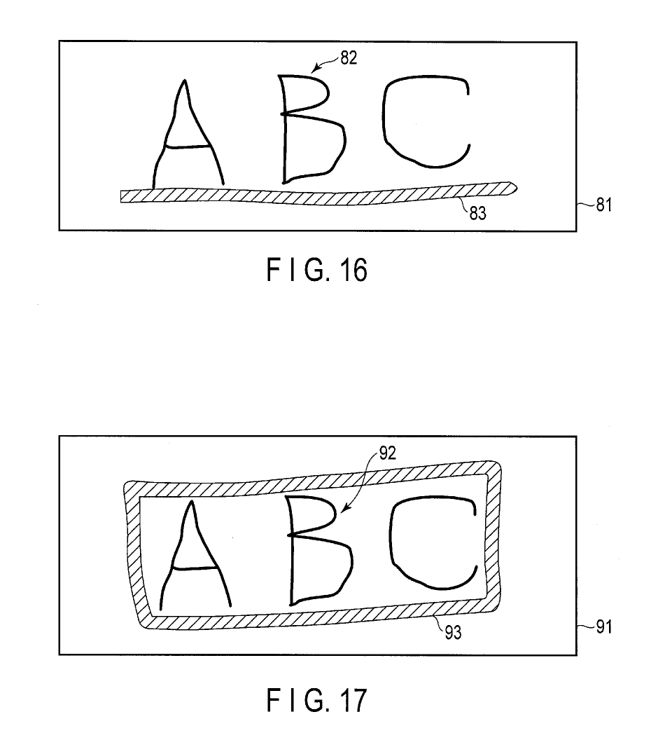

Next, another example of a handwritten document including a plurality of strokes handwritten by a plurality of pens (plurality of drawing modes) is described with reference to FIG. 16 and FIG. 17. In handwritten documents 81 and 91, strokes “ABC” 82 and 92 of a pencil (first mode) do not overlap strokes 83 and 93 of a marker pen (second mode).

However, an error may occur during a search based on strokes and character and figure recognition not only in a case where strokes of different modes overlap each other, but also in a case where such strokes are adjacent to each other. Therefore, the accuracy of the search based on strokes and the character and figure recognition can be improved by including data indicative of a drawing mode (for example, a pen ID) in stroke data as described in the present embodiment even in the case where a plurality of strokes handwritten in a plurality of drawing modes are adjacent to each other.

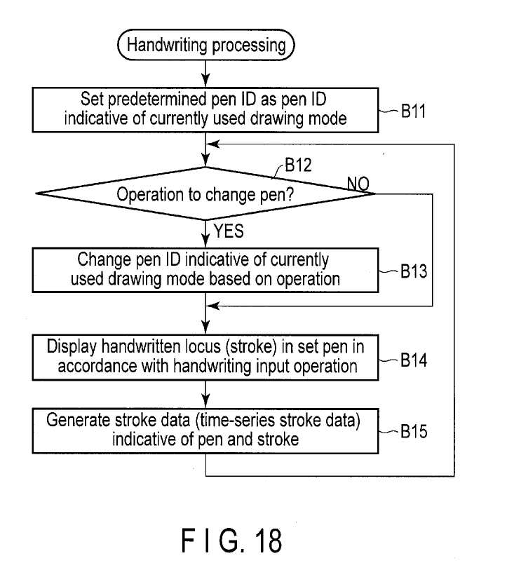

Next, an example of a procedure of handwriting processing executed by the digital notebook application program 202 is described with reference to FIG. 18.

First, the pen setting module 300 sets a predetermined pen ID as a pen ID indicative of a currently used drawing mode (block B11). The pen ID indicates, for example, identification data to identify a drawing mode (pen) having parameters such as a type of pen tip, a line width (thickness), a color, transmittance (density), etc., defined. Therefore, for example, an identification data (ID) is provided to a pen having an arbitrary combination of a type of pen tip, a line width, a color, transmittance, etc.

Next, the pen setting module 300 determines whether an operation to change a pen (pen change operation) is detected or not (block B12). As described above with reference to FIG. 14 and FIG. 15, the operation to change the pen is the user operation to select arbitrary one of the pens displayed in the menu or to set a pen having parameters designated.

If the operation to change the pen is not detected (NO in block B12), that is, the drawing mode (pen) of the currently set pen ID is continuously used, the processing proceeds to block B14. If the operation to change the pen is detected (YES in block B12), the pen setting module 300 sets a new pen ID based on the pen change operation as a pen ID indicative of a currently used drawing mode (block B13), and the processing proceeds to block B14.

Next, the locus display processor 301 displays a locus of a handwritten stroke by the currently set pen (drawing mode) in accordance with a handwriting input operation (block B14). Then, the time-series data generator 302 generates stroke data (time-series stroke data) indicative of the pen and the stroke (block B15). For example, the generated stroke data are stored as handwritten document data per handwritten document in the storage medium 402, etc.

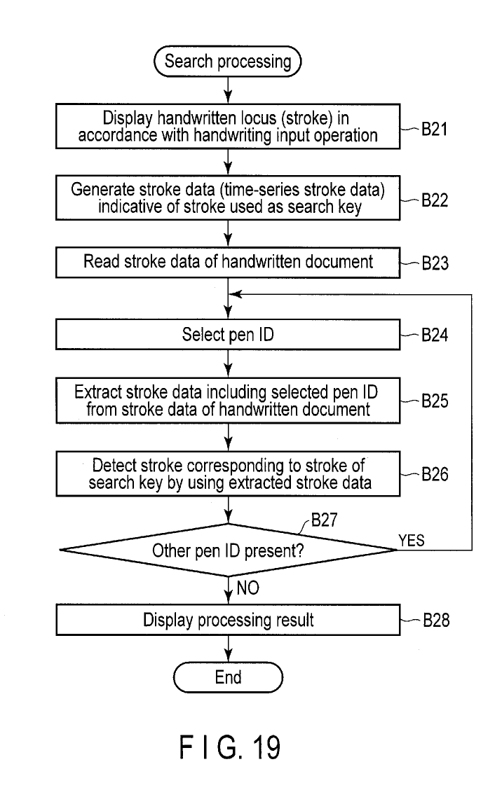

Next, an example of a procedure of the search processing executed by the digital notebook application program 202 is described with reference to FIG. 19. In the search processing, data of a stroke similar to an input search key is acquired from time-series data (stroke data) per pen ID based on the search key. In the description below, it is assumed that a search key input area to input the search key is displayed on the screen of the LCD 17A.

First, the locus display processor 301 displays a handwritten locus (stroke) in accordance with a handwriting input operation to the search key input area on the screen (block B21). Then, the time-series data generator 302 generates stroke data (time-series data) indicative of strokes used as the search key (block B22).

Next, the search and recognition module 303 reads stroke data of handwritten documents stored in the work memory 401, the storage medium 402, etc. (block B23). Stroke data included in a handwritten document includes time-series data indicative of a stroke handwritten in the handwritten document and a pen ID indicative of a drawing mode used when the stroke is handwritten.

The search and recognition module 303 selects one of a plurality of pen IDs corresponding to a plurality of pens that can be used in the handwritten documents (block B24). The search and recognition module 303 extracts stroke data including the selected pen ID from the stroke data of the handwritten documents read in block B23 (block B25). The extracted stroke data includes time-series data (stroke group) to be subjected to a search using the search key. The search and recognition module 303 detects a stroke corresponding to the stroke of the search key from the strokes on the handwritten documents by using the extracted stroke data (time-series data) (block B26). For example, the search and recognition module 303 determines that a first stroke corresponds to (is similar to) the search key stroke when a difference (absolute value of difference) between a feature amount of the stroke of the search key and a feature amount of a first stroke indicated by the extracted stroke data (time-series data) is lower than a threshold amount. For example, the search and recognition module 303 may determine that the first stroke corresponds to the search key stroke when a degree of similarity between a feature vector of the stroke of the search key and a feature vector of the first stroke indicated by the extracted time-series data (for example, an inner product of the feature vectors) is equal to or higher than a threshold amount.

Next, the search and recognition module 303 determines whether another unselected pen ID is present in (block B27). If an unselected pen ID is present (YES in block B27), the processing returns to block B24 and the search processing is executed for stroke data including the new pen ID. If an unselected pen ID is not present (NO in block B27), i.e., if the search processing for all the stroke data in the handwritten documents is completed, the search and recognition module 303 displays a result of the search processing on the screen of the touchscreen display 17 (block B28) and completes the processing. The search and recognition module 303 may display a result of processing executed for stroke data per pen ID (drawing mode) or display processing results of stroke data of a plurality of pen IDs.

By using the above procedure, the search and recognition module 303 can display, for example, a list of handwritten documents (list of thumbnails of handwritten documents) including the search key and a list of areas of the handwritten documents including the search key, in response to the input of the search key. The recognition processing can also be executed for stroke data per pen ID (drawing mode) in the same manner as the search processing.

As described above, according to the present embodiment, the handwritten document data can easily be processed. When first stroke is handwritten in a first mode and one or more second stroke is handwritten in a second mode different from the first mode, the locus display processor 301 and the page storage processor 306 receive document data including first stroke data corresponding to the first stroke and second stroke data corresponding to the second stroke. When a first display area of the first stroke at least partially overlaps a second display area of the second stroke and a first process for the document data is performed, the search and recognition module 303 can display either a first result of the first process executed only for the first stroke data or a second result of the first process executed only for the second stroke data. The processing result is thus displayed per drawing mode. Therefore, for example, the user can easily view the handwritten document.

All the procedures of the handwriting processing and the search processing (recognition processing) of the present embodiment can be executed by software. Therefore, the same advantage as the present embodiment can easily be achieved by installing the program that executes the procedures of the handwriting processing and the search processing (recognition processing) on a general computer through a computer-readable storage medium storing the program, and executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
receive, when one or more first stroke is handwritten in a first mode and one or more second stroke is handwritten in a second mode different from the first mode, document data including first stroke data corresponding to the first stroke and second stroke data corresponding to the second stroke; and
display, when a first display area of the first stroke at least partially overlaps a second display area of the second stroke and a first process for the document data is performed, either a first result of first process executed only for the first stroke data or a second result of the first process executed only for the second stroke data.

2. The electronic device of claim 1, wherein
the first process is search processing executed for the document data based on third stroke data corresponding to one or more third stroke, and
the circuitry is configured to display either a third result of the search processing executed only for the first stroke data based on the third stroke data or a fourth result of the search processing executed only for the second stroke data based on the third stroke data.

3. The electronic device of claim 1, wherein
the first processing is recognition processing, and
the circuitry is configured to display either a third result of the recognition processing executed only for the first stroke data or a fourth result of the recognition processing executed only for the second stroke data.

4. The electronic device of claim 1, wherein
the first processing is character recognition processing, and
the circuitry is configured to display either a third result of the character recognition processing executed only for the first stroke data or a fourth result of the character recognition processing executed only for the second stroke data.

5. The electronic device of claim 1, further comprising a touchscreen display, wherein
the first stroke data and the second stroke data are input via the touchscreen display, and
the circuitry is configured to display, on the touchscreen display, either the first result or the second result when the first display area at least partially overlaps the second display area.

6. A method for processing handwritten documents, the method comprising:
receiving, when one or more first stroke is handwritten in a first mode and one or more second stroke is handwritten in a second mode different from the first mode, document data including first stroke data corresponding to the first stroke and second stroke data corresponding to the second stroke; and
displaying, when a first display area of the first stroke at least partially overlaps a second display area of the second stroke and a first process for the document data is performed, either a first result of first process executed only for the first stroke data or a second result of the first process executed only for the second stroke data.

7. The method of claim 6, wherein
the first process is search processing executed for the document data based on third stroke data corresponding to one or more third stroke, and
the displaying comprises displaying either a third result of the search processing executed only for the first stroke data based on the third stroke data or a fourth result of the search processing executed only for the second stroke data based on the third stroke data.

8. The method of claim 6, wherein
the first processing is recognition processing, and
the displaying comprises displaying either a third result of the recognition processing executed only for the first stroke data or a fourth result of the recognition processing executed only for the second stroke data.

9. The method of claim 6, wherein
the first processing is character recognition processing, and
the displaying comprises displaying either a third result of the character recognition processing executed only for the first stroke data or a fourth result of the character recognition processing executed only for the second stroke data.

10. The method of claim 6, wherein
the first stroke data and the second stroke data are input via a touchscreen display, and
the displaying comprises displaying, on the touchscreen display, either the first result or the second result when the first display area at least partially overlaps the second display area.

11. A non-transitory computer-readable storage medium having stored thereon a computer program which is executable by a computer, the computer program comprising instructions capable of causing the computer to execute functions of:
receiving, when one or more first stroke is handwritten in a first mode and one or more second stroke is handwritten in a second mode different from the first mode, document data including first stroke data corresponding to the first stroke and second stroke data corresponding to the second stroke; and
displaying, when a first display area of the first stroke at least partially overlaps a second display area of the second stroke and a first process for the document data is performed, either a first result of first process executed only for the first stroke data or a second result of the first process executed only for the second stroke data.

12. The computer-readable storage medium of claim 11, wherein
the first process is search processing executed for the document data based on third stroke data corresponding to one or more third stroke, and
the displaying comprises displaying either a third result of the search processing executed only for the first stroke data based on the third stroke data or a fourth result of the search processing executed only for the second stroke data based on the third stroke data.

13. The computer-readable storage medium of claim 11, wherein
the first processing is recognition processing, and
the displaying comprises displaying either a third result of the recognition processing executed only for the first stroke data or a fourth result of the recognition processing executed only for the second stroke data.

14. The computer-readable storage medium of claim 11, wherein
the first processing is character recognition processing, and
the displaying comprises displaying either a third result of the character recognition processing executed only for the first stroke data or a fourth result of the character recognition processing executed only for the second stroke data.

15. The computer-readable storage medium of claim 11, wherein
the first stroke data and the second stroke data are input via a touchscreen display, and
the displaying comprises displaying, on the touchscreen display, either the first result or the second result when the first display area at least partially overlaps the second display area.
